(19) United States
(12) Patent Application Publication
(10) Pub. No.: US 2020/0146322 A1
(43) Pub. Date: May 14, 2020

(54) CARBOHYDRATE-BASED FLAVOR-CONTAINING GRANULES AND METHOD FOR PRODUCING THE SAME

(71) Applicant: International Flavors & Fragrances Inc., New York, NY (US)

(72) Inventors: Adam TOTH, Aberdeen, NJ (US); Ronald GABBARD, Farmingdale, NJ (US)

(73) Assignee: International Flavors & Fragrances Inc., New York, NY (US)

(21) Appl. No.: 16/617,314

(22) PCT Filed: Jun. 8, 2018
(86) PCT No.: PCT/US2018/036605

§ 371 Date: Nov. 26, 2019

Related U.S. Application Data
(60) Provisional application No. 62/516,767, filed on Jun. 8, 2017.

(51) Int. Cl. A23L 27/00; A23L 29/10; A23L 29/30; A23P 30/20; A23L 3/3562; A23P 10/20

(52) U.S. Cl. CPC A23L 27/70; A23L 29/10; A23L 29/35; A23L 27/72; A23L 3/3562; A23P 10/20; A23V 2002/00; A23P 30/20

(57) ABSTRACT

A flavor-containing granule formulation composed of a at least one carbohydrate for providing oxidative/volatile flavor stability and structure, at least one carbohydrate polymer as an emulsifier, and optionally at least one carbohydrate polymer as an anti-caking agent is described, as is a method for preparing the flavor-containing granule formulation.

### CROSS-REFERENCE TO RELATED APPLICATIONS

This application claims priority to U.S. application Ser. No. 62/516,767 filed on Jun. 8, 2017, the content of which is incorporated herein by reference in its entirety.

### BACKGROUND

Delivery systems or encapsulation systems are used in various industries to protect active ingredients. For instance, in the food industry they are often used to protect flavors, in particular against losses of volatile components (i) during storage prior to incorporation into food products, (ii) during mixing of the flavor with the other food ingredients, (iii) during food processing, e.g., cooking and baking, (iv) during transportation and storage and (v) during the preparation of the food product by the end-consumer.

Due to the importance of delivery systems across a broad array of fields, it is not surprising that various different types of delivery system exist. Among the different systems known in the art, extrusion methods typically rely on the use of matrix materials, which are heated to a molten state and combined with the active ingredient(s), such as an oxygen sensitive oil, before extruding and quenching the extruded mass to form a glass that protects the active ingredient(s). Such extrusion methods are typically referred to as “melt-extrusion.”

One example of the prior art disclosure in this field is in U.S. Pat. No. 2,856,291 (to Schultz), which describes a method for producing solid flavoring compositions by mixing a volatile liquid flavoring agent with an edible carrier base including a mixture of sugars such as dextrose (glucose), corn syrup, and dextrin; extruding the mixture to form a continuous stream; cooling the stream to attain a plastic condition and cutting the same to produce rod-like elements in which the flavoring agent is protected from vaporization and deterioration.

In U.S. Pat. No. 3,704,137 (to Beck) an essential oil composition is described, which is formed by mixing oil with an antioxidant, separately mixing water, sucrose and hydrolyzed cereal solids with a dextrose equivalent (D.E.) of below 20, emulsifying the two mixtures together, extruding the resulting mixture in the form of rods into a solvent, removing the excess solvent and finally, adding an anti-caking agent.

U.S. Pat. No. 3,971,852 (to Brenner et al.) teaches the use of modified starch, gums and other natural hydro-colloids with lower molecular weight polyhydroxy compounds such as glycerine, sorbitol, mannitol, erythritol and ribitol to yield a glassy cellular matrix with encapsulated oil at a maximum of 80 volume %.

In U.S. Pat. No. 4,420,534 (to Saleeb et al.) a matrix composition is described, which is composed of 10 to 30 wt % of a low molecular weight component chosen from a series of mono- or disaccharides, corn syrup solids, or organic acid with the balance of the mixture being maltodextrin. The matrix base is dry blended with an anhydrous liquid flavoring component and melted in a single screw extruder to yield a solid matrix characterized as a glass with a glass transition temperature >40° C.

In U.S. Pat. No. 4,532,145 (to Saleeb et al.), a process and composition are described in which a volatile flavorant is fixed by spray drying from a carrier solution made up of 10-30% of a low molecular weight component such as a sugar or an edible food acid with the balance of solids being a maltodextrin carbohydrate in the amount of 70-90%.

Further examples are described in U.S. Pat. Nos. 4,610,890 and 4,707,367 (each to Miller et al.) in which compositions are prepared by forming an aqueous solution containing a sugar (e.g. sucrose, lactose, levulose, dextrose, fructose and maltose, as well as polyols such as glycerin and even other sweeteners), a starch hydrolysate and an emulsifier (e.g., sulfoacetates of mono- and diglycerides as well as polyglycerol esters and lecithin). An essential oil is blended with the aqueous solution in a closed vessel under controlled pressure to form a homogeneous melt, which is then extruded into a relatively cold solvent, dried and combined with an anti-caking agent.

U.S. Pat. No. 4,689,235 (to Barnes et al.) describes a method for preparing an encapsulating matrix composition by mixing maltodextrin (D.E. 3-40), a disaccharide sugar (e.g. sucrose), a flavor and optionally an emulsifying agent (e.g., a mono-glyceride of stearic or oleic acid, a diglyceride or stearic or oleic acid, or a mixed mono-diglyceride of stearic or oleic acid) in a tank, extruding the mixture and comminuting the extruded rods into desired lengths.

U.S. Pat. Nos. 5,087,461 and 5,009,900 (both to Levine et al.), teach a composition composed of a modified food starch, maltodextrin (D.E. 5-10), corn syrup solids or a polydextrose (D.E. 21-42), and mono- and disaccharide components. The starch is a chemically modified, water-soluble starch and is used in an amount of 40 to 80% of the total mixture. The balance of the composition is composed of 10-40% of maltodextrin, 5 to 20% of corn syrup solids or polydextrose and 5-20% of mono- or disaccharide.

U.S. Pat. No. 5,124,162 (to Boskovic et al.) discloses a carrier mixture composed of mono- and disaccharides (22-45%), maltodextrins (25-50%), and a high molecular weight carbohydrate such as gum arabic, gum acacia or chemically modified starch (10-35%) to which flavoring agents are added and the subsequent solution spray dried to yield a free flowing powder with a bulk density of 0.50 g/cc.

U.S. Pat. No. 5,476,675 (to Lou et al.) teaches a method for preparing an edible, fiber containing flavor product in granular form by mixing a powdered flavor material with maltodextrin (D.E. 10), SOLKA-FLOC (powdered cellulose), sodium caseinate and sugar, extruding the mixture in the forms of strands, and cutting the strands in an unsolidified state.

In U.S. Pat. No. 6,187,351 (to Porzio et al.), extruded capsules are disclosed, which are composed of a flavor, maltodextrin (D.E. 5-10), a food polymer (e.g., methyl cellulose, hydroxypropyl methyl cellulose, high methoxypectin, gum arabic, locust bean gum, guar gum, gum ghatti, gum tragacanth, gum karaya, xanthan, pregelatinized starches, or gelatin) and a mono- or disaccharide or corn syrup solids having a D.E. of 24 to 42.

In U.S. Pat. No. 6,607,771 (to Benczedi et al.) discloses a process for preparing a granular delivery system, which includes the steps of preparing a mixture of a continuous phase carrier composed of a carbohydrate or carbohydrate derivative and an emulsifier such as lecithin or citric acid esters of fatty acids, wherein the continuous phase carrier contains a volatile flavor or fragrance compound; heating the mixture within a screw extruder; extruding the molten mass through a die and chopping the molten mass as it exits the die.

U.S. Pat. No. 6,902,751 (to Schleifenbaum et al.) describes a method for producing flavorings encapsulated in carbohydrates, which involves the extrusion of a carbohydrate mixture (e.g., hydrolyzed starches, mono- and/or disaccharides, such as maltose) containing a flavoring followed by die-face pelletization during the solidification phase.

US 2012/0027866 (to Gregson et al.) discloses a method of preparing a granular delivery system by creating a melt emulsion having a continuous phase and a dispersed active, wherein the continuous phase includes trehalose and a low dextrose equivalent carbohydrate that is not a hydrogenated starch hydrolyzate, forcing the melt emulsion through an die or orifice to form an extrudate, cooling and granulating the extrudate to form granules of the delivery system and optionally drying the granules.

US 2012/0231122 (to Tran) describes an emulsifier (e.g., gum ghatti, pectin, gum arabic, modified cellulosics, lecithin, arabinogalactan, proteins, saponin, quillaja, quillaja solid extract, and/or quillaic acid, polysorbates, and sugar esters) and non-digestible carbohydrate mixtures (e.g., gum Arabic, polydextrose, short chain fructose oligosaccharide, and resistant maltodextrins) for sugar free/non-cariogenic encapsulation applications.

### SUMMARY OF THE INVENTION

This invention provides a carbohydrate-based, flavor-containing granule formulation composed of at least one carbohydrate for providing oxidative flavor stability and structure, at least one carbohydrate polymer as an emulsifier, a flavor effective amount of one or more flavors, and optionally at least one carbohydrate polymer as an anti-caking agent. In some embodiments, the formulation includes at least two carbohydrates (e.g., maltodextrin, maltose, or a combination thereof) for providing oxidative flavor stability and structure. In other embodiments, the at least one carbohydrate for providing oxidative flavor stability and structure is from 25% to 50% by weight of the formulation. In certain embodiments, the formulation is non-cariogenic. In other embodiments, the at least one carbohydrate polymer as an emulsifier is from 15% to 45% (e.g., 15% to 35%) by weight of the formulation and is a modified starch (e.g., sodium octenyl succinate modified starch or OSA-modified starch). In further embodiments, the at least one carbohydrate polymer as an anti-caking agent is from 1% to 5% by weight of the formulation and is a derivatized cellulose or salt thereof. In a particular embodiment, the carbohydrate-based, flavor-containing granule formulation contains by weight (a) 30% to 45% (e.g., 32% to 42%) of maltose and maltodextrin, in which the weight ratio of maltose to maltodextrin is from 3:1 to 1:2, (b) 20% to 45% (e.g., 20% to 30% and 30% to 45%) of a modified starch, (c) 2% to 8% (e.g., 4% to 6%) of lecithin, (d) 10% to 30% (e.g., 15% to 20%) of one or more flavors, and optionally (e) 1% to 5% of a derivatized cellulose, or salt thereof as an anti-caking agent. Also provided are edible compositions such as beverage compositions, pharmaceutical compositions, nutraceutical compositions, chewing-gums and toothpastes containing any one of the granule formulations described above.

This invention further provides a method for preparing a carbohydrate-based, flavor-containing granule formulation by providing a powder blend containing at least one flavor stabilizing carbohydrate, at least one carbohydrate polymer as an emulsifier, at least one carbohydrate polymer as an anti-caking agent, and optionally a first flavor to form a powder blend; providing a liquid blend containing a second flavor and a liquid emulsifier; introducing the powder blend into a first zone of an extruder; introducing water into a second zone of the extruder to wet the powder blend; introducing the liquid blend into one or more zones of the extruder to produce a granule formulation; extruding the granule formulation from the extruder and cutting the extruded granule formulation. In one embodiment, the powder blend further includes at least one additional dry powder emulsifier. In another embodiment, the first flavor is 0% to 50% (e.g., 10% to 50%) of the total flavors contained in the final granule formulation. In a further embodiment, the liquid blend is introduced into three separate, consecutive zones of the extruder in a 60/30/10 ratio.

### DETAILED DESCRIPTION OF THE INVENTION

This invention provides a flavor-containing granule formulation suitable for use in food or confections, wherein flavor stabilizing, emulsifying, structural and anti-caking properties are controlled by edible carbohydrate polymers. In this respect, the granule formulation is primarily composed of a flavor effective amount of one or more flavors, at least one edible carbohydrate polymer, and water in appropriate relative amounts. The terms “particle” or “granule” are used interchangeably herein to refer to any comestible, or a generally recognized as safe (“GRAS”) food additive, in particulate form.

Flavors are commonly volatile compounds that normally contain a variety of constituents varying in chemical class, as well as physical and chemical characteristics. The term “volatile” as used herein refers to a compound or material that is readily vaporizable at a relatively low temperature. A flavor effective amount of a flavor is understood to mean an amount of an individual flavor required to contribute to the olfactory characteristics of the granule formulation, as well as the sum of the effects of each of the flavors. Thus, the flavors of the invention can be used to alter the taste characteristics of the granule formulation by modifying the taste reaction contributed by another ingredient in the granule formulation. The amount will vary depending on many factors including other ingredients, their relative amounts and the effect that is desired. However, in some embodiments, the level of most flavors employed is greater than 1% by weight of the granule, generally provided at a level of from 1% to 40%, more preferably from 10% to 25%, and most preferably from 15% to 20% by weight of the granule.

Flavors of use in the granule formulation of the invention generally include essential oils, synthetic flavors, artificial flavors, or mixtures thereof including but not limited to oils derived from plants and fruits such as lemon, berry, orange, grapefruit, tangerine, lime, kumquat, mandarin, bergamot, citrus oils, fruit essences, peppermint oil, spearmint oil, clove oil, oil of wintergreen, anise, and the like.

More particularly, flavors of the granule formulation of the invention can include saturated fatty acids, unsaturated fatty acids and amino acids; alcohols including primary and secondary alcohols, esters, carbonyl compounds including ketones and aldehydes; lactones; other cyclic organic materials including benzene derivatives, alicyclic compounds, heterocyclics such as furans, pyridines, pyrazines and the like; sulfur-containing compounds including thiols, sulfides, disulfides and the like; proteins; lipids, carbohydrates; flavor potentiators such as monosodium glutamate; magnesium glutamate, calcium glutamate, guanylates and inosinates; natural flavoring materials such as cocoa, vanilla and caramel; essential oils and extracts such as anise oil, clove oil and the like and artificial flavoring materials such as vanillin, ethyl vanillin and the like.

Specific flavors include, but are not limited to, acetoin; acetyl furan; alkyl pyrazine; alkyl thiophene; amyl acetate; amyl cinnamate; anethol; anise oil; benzaldehyde; butyl valerate; butyrolactone; cardamom oil; cinnamaldehyde; clove oil; cocoa extract; coffee extract; 2,4-decadienal; β-decalactone; diacetyl; diallyl disulfide; diallyl trisulfide; 2,3-diethyl pyrazine; 3,4-dimethoxyphenol; 2,5-dimethylfuran-3-thiol; 4,5-dimethyl-2-(methylthiomethyl)-1,3-dithiolane; 2,3 -dimethyl thiophene; dipropyl disulfide; dipropenyl trisulfide; ethyl acetate; ethyl butyrate; ethyl maltol; ethyl-2-methyl butyrate; 2-ethyl-3-methyl pyrazine; ethyl-2-methyl valerate; ethyl valerate; ethyl vanillin; furfural; furfuryl alcohol; guaiacol; 2,4-heptadienal; trans-2-heptenal; cis-3-heptenol; n-hexanal; cis-3-hexenol; γ-hexenyl lactone; hydrolyzed fish protein; hydrolyzed vegetable protein; isovaleraldehyde; levulinic acid; d-limonene; maltol; 2-methyl butanethiol; methyl cyclopentenolone; 4-mercapto-2-butanone; 3-mercapto-2-pentanone; 1-mercapto-2-propane; 2-mercapto propionic acid; methyl benzyl disulfide; 2-methyldihydrofuran-3-thiol; 2-methylfuran-3 -thiol; 5-methyl furfural; 4-methyl-2-[(methylthio)-ethyl]-1,3-dithiolane; 4-methyl-2-(methylthiomethyl)-1,3-dithiolane; methyl pyrazine; methyl thiazole alcohol (4-methyl-5-β-hydroxyethyl thiazole); monopotassium glutamate; monosodium glutamate; n-octanal; n-pentanal; peppermint oil; phenyl acetaldehyde; phenyl acetic acid; piperonal; polysulfides; propylpropenyl disulfide; propylpropenyl trisulfide; spearmint oil; sulfur-containing amino acids, e.g., cysteine; tetramethyl pyrazine; trimethyl pyrazine; vanillin; valerian oil and wintergreen oil. These and other flavors are provided in U.S. Pat. Nos. 6,110,520 and 6,333,180.

As indicated, the flavor stabilizing, emulsifying, structural and anti-caking properties of the granule formulation are provided by at least one edible carbohydrate polymers. In some embodiments, the granule formulation includes at least one carbohydrate for providing oxidative/volatile flavor stability and structure, at least one carbohydrate polymer as an emulsifier, and at least one carbohydrate polymer as an anti-caking agent. In other embodiments, the granule formulation includes at least two carbohydrates for providing oxidative/volatile flavor stability and structure, at least one carbohydrate polymer as an emulsifier, and at least one carbohydrate polymer as an anti-caking agent.

A carbohydrate that provides oxidative/volatile flavor stability refers to a carbohydrate that inhibits, prevents, delays or reduces the oxidation of one or more flavors present in the granule formulation by trapping or coating the flavor therein and retaining, maintaining or preserving the one or more flavors during storage. A number of methods are well known to those skilled in the art for determining oxidative stability including, but not limited to, the Active Oxygen Method (AOM), sensory testing, purge and trap techniques, electron spin resonance (ESR) and gas chromatography.

The flavor stabilizing carbohydrate also provides structure to the granule formulation. In particular, the carbohydrate can form a structure that traps or coats the flavor and confers the formulation with sufficient flowability for granule formation, as well as an authentic flavor and/or taste release. The flavor stabilizing carbohydrate is a food grade material, and may be maltodextrin, maltose, or a combination thereof.

Commercial maltodextrins are usually prepared from hydrolysis of corn starch or potato starch with safe and suitable acids and enzymes. Maltodextrins are classified based upon their dextrose equivalent (referred to herein as “DE”), which refers to the percentage of reducing sugars (dry basis) in a product calculated as dextrose. Any commercial maltodextrin with 5 DE to 20 DE may be suitably used. However, maltodextrins with 10 DE to 20 DE are preferred. Most preferably maltodextrins having 10 DE are used.

Commercial maltodextrins are typically spray-dried and sold as powders, although some liquid maltodextrins are available. Preferably, the maltodextrin used in the preparation of the granule formulation is a dry powder. Suitable commercially available maltodextrins for use in the present invention include products under the trademarks of STAR-DRI™ 10 (Tate & Lyle), MALTRIN™ M100 or MALTRIN™ M150 (Grain Processing), GLOBE™ Plus Ultra-Lite Maltodextrin (Corn Products U.S.), MALDEX™ Low DE Maltodextrin (Tereos Syral), and Dry MD™ maltodextrins (Cargill). Other commercial maltodextrin-like materials obtained from rice, wheat, and tapioca starches are also included within the scope of this invention.

In the granule formulation, the amount of flavor stabilizing carbohydrate is preferably from 25% to 50% by weight, wherein the lower limit of the amount may be 25, 27, 28, 29, 30, 31 or 32%, and the upper limit of the amount may be 50, 48, 47, 46, 45, 43 or 42%, based on the total dry weight of the granule formulation. If the amount of the carbohydrate is lower than 25%, the structure stability of a granule tends to decrease.

In some embodiments, the flavor stabilizing carbohydrate is a combination of maltodextrin and maltose. In accordance with this embodiment, the ratio of maltose to maltodextrin may be in the range of 5:1 to 1:2 (e.g., 3:1 to 1:2 and 2:1 to 1:2). Preferably, the amount of maltodextrin is from 10 to 35% by weight, wherein the lower limit of the amount may be 10, 12, 14, 15, 16 or 17%, and the upper limit of the amount may be 35, 33, 31, 30, 29, 28 or 27%, based on the total dry weight of the granule formulation. The amount of maltose is in the range of 10 to 35% by weight, wherein the lower limit of the amount may be 10, 12, 14, 15, 16 or 17%, and the upper limit of the amount may be 35, 33, 31, 30, 29, 28 or 27%, based on the total dry weight of the granule formulation.

In some embodiments, the granule formulation is non-cariogenic, in that the granule formulation does not contribute to the advancement of dental caries. In this respect, the granule formulation does not include monosaccharides (glucose, galactose, and fructose) or disaccharides (sucrose, lactose, and trehalose). Accordingly, the flavor stabilizing carbohydrate may include maltodextrin alone or maltodextrin in combination with one or more other non-carogenic carbohydrates.

In addition to the flavor and flavor stabilizing carbohydrate, the granule formulation also includes a carbohydrate with emulsifying properties. According to this invention, a “carbohydrate polymer with emulsifying properties” or “carbohydrate-based emulsifier” is an oligosaccharide, polysaccharide or modified (food) starch that decreases the interfacial tension between conflicting components such as water and oil. The carbohydrate-based emulsifier component of the granule formulation may be composed of a single emulsifier or a mixture of emulsifiers. In accordance with this invention, the carbohydrate-based emulsifier is a gum arabic, a modified cellulose, a modified starch, or a combination thereof. In certain embodiments, the carbohydrate-based emulsifier is a modified starch.

Native starch is not hydrophobic, and thereby generally not suitable to adsorb to the interface of water and oil and thus to stabilize an emulsion. However, by modification of starches, the hydrophobicity can be increased. Starch can be chemically modified by treatment with different alkenyl succinic anhydrides, for example, octenyl succinic anhydride (OSA), wherein the hydrophobic octenyl group and the carboxyl or sodium carboxylate group increase the ability of the starch to stabilize an emulsion. Emulsification with gelatinized and dissolved OSA-modified starch has been found to be independent of starch concentration (above necessary limit for stabilization), pH value, and ion valence (Tesch, et al. (2002) J. Food Eng. 54:167-174). OSA-modified starches from waxy corn and amaranth have also shown to have emulsification capacity, which was independent of the degree of substitution (DS) and type of starch. See Bhosale & Singhal (2006) Carbohydr. Polym. 66:521-527.

Another way to increase the hydrophobicity of starch is by dry heating, causing starch granule surface proteins to change character from hydrophilic to hydrophobic. See Seguchi (1984) Cereal Chem. 61:248-250; and Madivala, et al. (2009) Soft Matter. 5:1717-1727. An advantage of thermal modification is that no specific labeling is required when used in food applications. Furthermore, the hydrophobic alteration is explicitly occurring at the granule surface.

Examples of suitable starches of use as an emulsifier in granule formulation of the invention include, but are not limited to, heated-treated quinoa starch, OSA-modified quinoa starch, heated-treated waxy rice starch, OSA-modified waxy rice starch, heated-treated rice starch, OSA-modified rice starch, heated-treated waxy maize starch, OSA-modified waxy maize starch, heated-treated maize starch, OSA-modified maize starch, heated-treated HYLON VII starch, OSA-modified HYLON VII starch, heated-treated waxy barley starch, and OSA-modified waxy barley starch. In certain embodiments, the carbohydrate-based emulsifier used in the preparation of the granule formulation is in the form of a dried powder.

The carbohydrate-based emulsifier content of the granule formulation is at least 15%, based on the total weight of the granule formulation. A preferred range is 15% to 35%, or more preferably 20% to 30% of a carbohydrate-based emulsifier, based on the total weight of the granule formulation.

In addition to a carbohydrate-based emulsifier, the granule formulation can further include one or more additional emulsifiers. Suitable food grade emulsifiers are well-known in the art and are described in U.S. Pat. Nos. 4,479,969 and 6,190,705, the contents of which are incorporated by reference. More specifically, suitable emulsifiers include, but are not limited to, gum ghatti, pectin, modified celluloses, lecithin, arabinogalactan, proteins, saponin, polysorbates, sugar esters, quillaja, quillaja solid extract, quilliac acid, and/or any combination thereof. Lecithins and modified lecithins are particularly preferred emulsifiers for use in combination with the carbohydrate-based emulsifier. The lecithin can be in liquid and/or powder form and can be obtained from a variety of sources including soy, canola, sunflower, rapeseed or egg. Suitable examples of liquid lecithins include, but are not limited to, products under the trademarks of YELKIN™ SS soy lecithin (Archer Daniel Midlands); TOPCITHIN™, LECIPRIME™, LECISOY™ and CHOCOTOP™ fluid lecithins (Cargill); EMULPUR™, LECIGRAN™, EMULTOP™ and LECIMULTHIN™ de-oiled lecithins (Cargill) and METARIN™ and EMULFLUID™ fractionated lecithins (Cargill). Examples of dry, powdered lecithins include, but are not limited to, the VEROLEC™ or GIRALEC™ series of standardized, de-oiled, hydrolyzed, or highly hydrolyzed lecithins (Lasenor) and the ALCOLEC™ series of soy, canola, sunflower or egg lecithins (American Lecithin Company). In certain embodiments, the granule formulation is prepared with both a liquid lecithin and a dry powder lecithin. In other embodiments, the granule formulation is prepared with a liquid lecithin and a de-oiled dry powder lecithin.

The one or more additional emulsifiers (i.e., in addition to the carbohydrate-based emulsifier) can be provided at from 1% to 10%, or preferably 1% to 8%, or more preferably 3% to 8%, or most preferably 4% to 6%, based on the total weight of the granule formulation. When, the granule formulation is prepared with two additional emulsifiers, e.g., a liquid lecithin and a dry powder lecithin, preferably at a ratio of 3:1 to 1:3 (e.g., 1:1).

The granule formulation also includes a carbohydrate-based anticaking agent. For the purposes of this invention, an anticaking agent is a substance that absorbs excess moisture and prevents or reduces caking thereby retaining the free-flowing characteristics of the granule formulation and improving granule stability. Preferably, the anticaking agent is a hydrophobic, gel-forming-or-slow dissolving (e.g., in water) carbohydrate. The anticaking agent can be provided at from 1% to 5% (e.g., 2% to 4%, and preferably 2%, based on the weight of the granule formulation. Suitable carbohydrate-based anticaking agents include derivatized celluloses, such as HPMC (hydroxypropyl methylcellulose), CMC (carboxymethyl cellulose), HEC (hydroxylethyl cellulose), or salts thereof, e.g., sodium CMC. If desired, one or more additional anticaking agents can be added to the final extruded granule formulation) to further reduce the risk of the granules from sticking to one another.

Other ingredients can be present in the granule formulation. For instance, water may be present to modify the characteristics of the carbohydrates. For example, for a carbohydrate glass having a DE (dextrose equivalent) of 10, from 1% to 10% of water in the mixture may be present in the granule formulation. Similarly, adjuvants such as food grade colorants can also be added in a generally known manner, to the extrudable mixtures of the invention so as to provide colored delivery systems. Moreover, additional absorbents can be added to further improve stability of the granules. For example, from 1% to 8%, more preferably 3% to 6%, or most preferably 4% to 5% silica (silicon dioxide) can be added to the granule formulation as an absorbent.

An example of a general granule formulation is provided in Table 1.

TABLE 1

| Ingredient | wt % |
|---|---|
| Flavor stabilizing carbohydrate | 30-45% |
| Carbohydrate-based emulsifier | 30-45% |
| Carbohydrate-based anticaking agent | 2% |
| Optional absorbent | 4.5% |
| Additional emulsifier (dry and/or liquid) | 4-6% |
| Flavor | 15-20% |
| Water | 3% |

A more specific example of a general granule formulation is provided in Table 2.

TABLE 2

| Ingredient | Example | % Range |
|---|---|---|
| Flavor stabilizing | Maltodextrin and | 30-45% |
| carbohydrate | maltose | |
| Carbohydrate-based | Modified starch | 30-45% |
| emulsifier | | |
| Carbohydrate-based | Derivatized cellulose, | 2% |
| anticaking agent | or salt thereof | |
| Optional absorbent | Silicon dioxide | 4.5% |
| Additional emulsifier | Lecithin | 4-6% |
| Flavor | Essential oils, synthetic | 15-20% |
| | flavor, and/or artificial | |
| | flavor | |
| Water | | 3% |

This invention also provides a process for the preparation of flavor-containing granules. The process for preparing the granules involves extrusion using any suitable extruder typically used for “wet extrusion” or “dry blend” (also called “flash-flow”) techniques. A typical extruder has multiple zones (e.g., two or more zones, three or more zones, and four or more zones) where each zone is a separate barrel with an individual temperature control.

The dry blend technique requires feeding of a melt of a solid mass into the extruder. The wet extrusion technique requires the extrusion of a mainly fluid mass melt resulting from the prior solution of the matrix in a suitable solvent. By extrusion it is meant that the components of the carbohydrate matrix, the flavor that is to be encapsulated, a plasticizer (water), and an optional additional emulsifier are prepared as a melt-emulsion, which is forced through a die and then quenched or cooled to form a solid product having the encapsulated material dispersed therein. The melt can be formed in any way known in the art. This includes the heating of matrix ingredients to a temperature which allows the formation of a homogeneous melt, for example in a single or twin screw extruder.

In one embodiment, the granule formulation is prepared by (a) providing a powder blend containing at least one flavor stabilizing carbohydrate, at least one carbohydrate-based emulsifier, at least one carbohydrate-based anticaking agent and a first flavor; (b) providing a liquid blend containing a second flavor and an emulsifier, preferably a liquid emulsifier; (c) feeding the powder blend into a first zone of an extruder; (d) feeding water into a second zone of the extruder to wet the powder blend; (e) feeding the liquid blend into the one or more zones of the extruder to produce a granule formulation; (f) extruding the granule formulation from the extruder and (g) cutting the extruded granule formulation. The first flavor and the second flavor can be the same or different. Further, one or more additional flavors (a third, a fourth, etc.) can be fed into the extruder through one of the zones. The liquid blend can be fed into one or more zones after water is fed into the extruder. Preferably, it is fed into a third zone. The terms “first zone,” “second zone,” “third zone,” and the like each refer to a separate section or barrel of the extruder and do not necessarily arranged consecutively or in the order as indicated.

In another embodiment, the granule formulation is prepared by (a) providing a powder blend containing at least one flavor stabilizing carbohydrate, at least one carbohydrate-based emulsifier, and at least one carbohydrate-based anticaking agent, in which the powder blend is preferably free of a flavor; (b) providing a liquid blend containing a flavor and an emulsifier, preferably a liquid emulsifier; (c) feeding the powder blend into a first zone of an extruder; (d) feeding water into a second zone of the extruder to wet the powder blend; (e) feeding the liquid blend into one or more zones of the extruder to produce a granule formulation; (f) extruding the granule formulation from the extruder and (g) cutting the extruded granule formulation. The liquid blend can be fed into the first zone, the second zone, a third zone, or any combination thereof. Preferably, a portion of the liquid blend is fed into the first or second zone and another portion of the liquid blend is fed into a fourth zone of the extruder. In some embodiments, a second flavor is fed into the first zone, the second zone, the third zone, the fourth zone, or any combination thereof. As a illustration, the powder blend is fed into a first zone, followed by feeding a small portion (e.g., 10% to 30% by weight) of the liquid blend into a second zone, and then water is fed into a third zone to wet the powder blend, and the remaining liquid blend is fed into a fourth zone or more zones after water is fed.

In certain embodiments of this invention, the at least one flavor stabilizing carbohydrate, at least one carbohydrate-based emulsifier, and at least one carbohydrate-based anticaking agent are provided as dry powders. In other embodiments, the powder further includes at least one additional dry powder emulsifier and/or an optional absorbent.

For the purposes of this method, a first flavor constitutes at least 10% of the total flavors incorporated in the granule formulation. More generally, the first flavor constitutes 10% to 50% of the total flavors, or more preferably 20% to 40% of the total flavors. The second flavor constitutes 50 to 90% of the total flavors.

The extruder may be a single screw or a twin screw extruder such as products commercially available under the trademark of MAPIMPIANTI™ and WENGER™ (single screw extruders), and BUHLER™, WENGER™, CLEXTRAL™ or WERNER & PFLEIDERER™ twin screw extruders, or READCO™, TELEDYNE™ or AOUSTIN™ twin screw mixers. Preferably, to achieve suitable mixing of the ingredients of the granule formulation, the extruder has at least three zones: a first zone for providing, feeding or introducing the powder blend; a second zone for providing, feeding or introducing water to wet the powder blend; and a third zone for providing, feeding or introducing the liquid blend containing a flavor. In some embodiments, the liquid blend is introduced into more than one zone of the extruder. In certain embodiments, portions of the liquid blend are introduced into three separate zones of the extruder. In accordance with this embodiment, the liquid blend is introduced into three separate, consecutive zones of the extruder in a 60/30/10 ratio.

Once extruded, the extruded product can then be formed into granules by any suitable means. For instance, it can be cooled and subsequently milled, ground, pulverized or the like. If desired, a cutter-knife or any other cutting device can be affixed downstream of the die orifice itself so that the extruded product is cut while it is still in a plastic state.

The granules optionally can then be dried, such as in a fluid bed drier or, in case of the fluid bed agglomeration, desirably can be immediately dried (in the agglomerator) to obtain (solid dry) granules. Other known methods for drying granules in the food or feed industry can be used by the skilled person. Preferably, the granule is flowable.

The drying preferably takes place at a temperature of from 25° C. to 60° C., such as 30° C. to 50° C. Here the drying can last from 10 minutes to 24 hours, such as 15 minutes to 10 hours, preferably from 15 minutes to 3 hours, or desirably from 15 minutes to 30 minutes. The length of time required will of course depend on the amount of granules to be dried. After drying the granules, the resulting granule preferably has a water content of from 3% to 10%, such as from 5% to 9%.

A coating preferably can be applied to the granules to give additional (e.g., anticaking or flavored) characteristics or properties, like low dust content or color. The granules can be coated with a fat, wax, polymer, salt, anticaking agent (e.g., silicon dioxide and/or calcium stearate) or a combination thereof. It will be apparent that if desired several layers of (different) coatings can be applied. To apply the coating(s) onto the granules a number of known methods are available which include the use of a fluidized bed, a high shear granulator, a mixer granulator, or a conical screw blender. The coating can be applied in a batch or continuous process.

The resultant granule formulation is, in one embodiment, in the form of a dry, free-flowing powder. This product has the advantage of achieving and maintaining consistently high flavor levels, and/or excellent oxidation resistance. In particular, the flavor of the granule formulation may be present in an amount of from 5% to 70% based upon the final product. In another embodiment, the flavor is present in an amount of from 20% to 70%. The granule formulation can thus be used to enhance a variety of products. For instance, it can deliver a flavor to edible compositions, pharmaceutical compositions, nutraceutical compositions, chewing-gum or toothpaste.

The term “edible composition,” as used herein, includes both solid and liquid ingestible materials for man or animals, which materials usually do, but need not, have nutritional value. Thus, edible compositions include tea (such as leaf tea), dry beverage mix, chewing gums, extruded cereal, extruded snacks, meats, gravies, soups, convenience foods, malt, alcoholic and other beverages, milk and dairy products, seafoods, including fish, crustaceans, mollusks and the like, candies, vegetables, cereals, soft drinks, snacks, baked goods, dog and cat foods, other veterinary products and the like.

The following non-limiting examples are provided to further illustrate the present invention. All publications cited herein are incorporated by reference in their entirety.

### EXAMPLE 1: CARBOHYDRATE-BASED GRANULE FORMULATION

Dry powders (maltose, OSA-modified starch, sodium carboxymethyl cellulose, silicon dioxide, 10 DE maltodextrin and de-oiled sunflower lecithin; Table 3) were mixed together. Thirty percent of the flavor was plated onto the powder blend and the remaining 70% was blended with the liquid sunflower lecithin and prepared for injection. The powder blend was fed into the first zone of an extruder. Water was fed into the second zone of the extruder. The flavor/lecithin mixture was fed into zones 5, 6 and 7 of the extruder in a 60/30/10 ratio. The final product exited the extruder as stands, which were cooled on a belt and subsequently milled into smaller rods. The rods were treated with a mixture of 1% calcium stearate and 0.5% silicon dioxide as anticaking agents.

The physical properties of the granule formulation were assessed and it was found that there was a high level of flavor retention; however, the level of retention was dependent upon the type flavor used. In particular, while there was 60% to 70% retention of DMS and ethyl acetate, acetaldehyde achieved 20% retention. The granules themselves had a completely amorphous structure with the glass transition temperature (Tg) ranging from 15° C. to 35 ° C. Notably, all prototypes were stable at 40 ° C. elevated storage and passed hygroscopicity testing for 7 days at 30° C./65% relative humidity regardless of low Tg.

TABLE 3

| | % | |
|---|---|---|
| Ingredient | Range | Function |
| Maltose, dry powder | 15% | Oxidative/volatile stability |
| | | Structure |
| OSA-modified food | 20-30% | Emulsifier |
| starch, dry powder | | |
| Sodium carboxymethyl | 2% | Anticaking |
| cellulose, dry powder | | |
| Silicon dioxide, dry | 4.5% | Absorbent |
| powder | | |
| 10 DE Maltodextrin, | 17-27% | Oxidative/volatile stability |
| dry powder | | Structure |
| De-oiled sunflower | 2-3% | Emulsifier |
| lecithin, dry powder | | |
| Sunflower lecithin, | 2-3% | Emulsifier |
| liquid | | |
| Flavor | 15-20% | Active |
| Water | 3% | Plasticizer |
| | | Increased water activity |

### EXAMPLES 2-8

Table 4 below shows Formulations 2 to 8 of this invention, which were prepared following the procedure described above except that amounts of materials were different.

Each of Formulations 2-8 were tested for performance and hygroscopicity (30 ° C./65% humidity). Each sample passed both tests.

Samples that are free flowing pass the performance test. To evaluate the hygroscopicity, samples are weighed in an open pan and stored for up to 7 days and monitored for moisture uptake and physical appearance. Samples that are free flowing pass the test. Samples that cake and go through physical changes fail the test.

TABLE 4

| Formulation | 2 | 3 | 4 | 5 | 6 | 7 | 8 |
|---|---|---|---|---|---|---|---|
| OSA-Modified Starch | 30% | 30% | 30% | 30% | 30% | 40% | 20% |
| Maltose | 15% | 20% | 15% | 15% | 15% | 15% | 35% |
| Maltodextrin | 17.5% | 13.5% | 19.5% | 21.5% | 24.5% | 18.4% | 12.5% |
| Maltose/maltodextrin | 1:1.2 | 1.5:1 | 1:1.3 | 1:1.4 | 1:1.6 | 1:1.2 | 2.8:1 |
| Na-CMC | 2% | 2% | 2% | 2% | 2% | 2% | 0% |
| Silica | 4.5% | 4.5% | 4.5% | 4.5% | 4.5% | 2.6% | 4.5% |
| De-oiled Lecithin | 5.4% | 5.4% | 3% | 3% | 2% | 2% | 5.4% |
| Flavor | 20% | 20% | 20% | 18% | 17% | 15% | 20% |
| Sunflower Lecithin | 2.6% | 2.6% | 3% | 3% | 2% | 2% | 2.6% |
| Water | 3% | 2% | 3% | 3% | 3% | 3% | 0% |

A comparative formulation was also prepared following the same procedure described in Example 1 except that different amounts of materials were use. The comparative formulation contained by weight 27.5% of OSA-Modified Starch, 35% of Maltose, 2% of Na-CMC, 4.5% of Silica, 3% of Maltodextrin, 5.4% of De-oiled Lecithin, 20% of Flavor, 2.6% of Sunflower Lecithin, and 0% of Water. The comparative composition failed the hygroscopicity performance test described above.

### EXAMPLE 9

Formulation 9 of this invention was also prepared following the same procedure described in Example 1 except that no flavor was plated onto the powder blend and 100% of the flavor was injected into the extruder, with the first portion into the second zone and then the remaining portion was injected into multiple zones after the third zone of the extruder. In this example, water was injected in the third zone. Formulation 9 contained by weight 30% of OSA-Modified Starch, 15% of Maltose, 2% of Na-CMC, 4.5% of Silica, 17.5% of Maltodextrin, 5% of De-oiled Lecithin, 20% of Flavor, 3% of Sunflower Lecithin, and 3% of Water. Formulation 9 passed both the performance and the hygroscopicity tests.

1. A carbohydrate-based, flavor-containing granule formulation comprising (a) at least one carbohydrate for providing oxidative flavor stability and structure, (b) at least one carbohydrate polymer as an emulsifier, and (c) a flavor effective amount of one or more flavors,

2. The carbohydrate-based, flavor-containing granule formulation of claim 1, wherein the granule formulation comprises at least two carbohydrates for providing oxidative flavor stability and structure, and the at least two carbohydrates for providing oxidative flavor stability and structure are maltodextrin and maltose.

3. The carbohydrate-based, flavor-containing granule formulation of claim 1, wherein the weight ratio of maltose to maltodextrin is from 3:1 to 1:2.

4. The carbohydrate-based, flavor-containing granule formulation of claim 2, wherein the at least two carbohydrate for providing oxidative flavor stability and structure is present at a level of from 25% to 50% by weight of the formulation.

5. The carbohydrate-based, flavor-containing granule formulation of claim 1, further comprising by weight of the formulation 1% to 5% of a derivatized cellulose or salt thereof as an anti-caking agent.

6. The carbohydrate-based, flavor-containing granule formulation of claim 2, wherein the maltodextrin comprises from 10% to 35% by weight of the formulation and the maltose comprises from 10% to 35% by weight of the formulation.

7. The carbohydrate-based, flavor-containing granule formulation of claim 1, wherein the formulation is non-cariogenic.

8. The carbohydrate-based, flavor-containing granule formulation of claim 1, wherein the at least one carbohydrate polymer as an emulsifier contains a modified starch.

9. The carbohydrate-based, flavor-containing granule formulation of claim 1, wherein the at least one carbohydrate polymer as an emulsifier comprises from 15% to 45% by weight of the formulation.

10. The carbohydrate-based, flavor-containing granule formulation of claim 1, further comprising one or more additional emulsifiers.

11. A carbohydrate-based, flavor-containing granule formulation comprising by weight of the formulation:
(a) 30% to 45% of a maltose and maltodextrin, in which the weight ratio of maltose to maltodextrin is from 3:1 to 1:2,
(b) 30% to 45% of a modified starch,
(c) 2% to 8% of lecithin, and
(e) 10% to 30% by weight of one or more flavors.

12. The carbohydrate-based, flavor-containing granule formulation of claim 11, further comprising by weight of the formulation 1% to 5% of a derivatized cellulose or salt thereof as an anti-caking agent.

13. A method for preparing a carbohydrate-based, flavor-containing granule formulation comprising
(a) providing a powder blend containing at least one flavor stabilizing carbohydrate, at least one carbohydrate polymer as an emulsifier, at least one carbohydrate polymer as an anti-caking agent, and a first flavor;
(b) providing a liquid blend containing a second flavor and a liquid emulsifier;
(c) introducing the powder blend into a first zone of an extruder;
(d) introducing water into a second zone of the extruder to wet the powder blend;
(e) introducing the liquid blend into one or more zones of the extruder to produce a granule formulation;
(f) extruding the granule formulation from the extruder and
(g) cutting the extruded granule formulation.

14. A method for preparing a carbohydrate-based, flavor-containing granule formulation comprising
(a) providing a powder blend containing at least one flavor stabilizing carbohydrate, at least one carbohydrate polymer as an emulsifier, and at least one carbohydrate polymer as an anti-caking agent;
(b) providing a liquid blend containing a flavor and a liquid emulsifier;
(c) introducing the powder blend into a first zone of an extruder;
(d) introducing water into a second zone of the extruder to wet the powder blend;
(e) introducing the liquid blend into one or more zones of the extruder to produce a granule formulation;
(f) extruding the granule formulation from the extruder and
(g) cutting the extruded granule formulation.

15. The method of claim 13, wherein the powder blend further comprises at least one additional dry powder emulsifier.

16. The method of claim 13, wherein the first flavor comprises 10% to 50% of the flavors contained in the granule formulation.

17. The method of claim 13, wherein step (e) comprises introducing the liquid blend into three separate, consecutive zones of the extruder in a 60/30/10 ratio.

18. An edible composition, pharmaceutical composition, nutraceutical composition, chewing-gum or toothpaste comprising the carbohydrate-based, flavor-containing granule formulation of claim 1.

19. The method of claim 14, wherein the powder blend further comprises at least one additional dry powder emulsifier.

20. The method of claim 14, wherein step (e) comprises introducing the liquid blend into three separate, consecutive zones of the extruder in a 60/30/10 ratio.
